(19) United States
(12) Patent Application Publication
(10) Pub. No.: US 2005/0036402 A1
(43) Pub. Date: Feb. 17, 2005

(54) Mixer apparatus

(76) Inventor: William S. Knight, Brodhead, WI (US)

Correspondence Address: DAVID J. ARCHER, 7037 CONEROY RD., ROCKTON, IL, 61072, US

(21) Appl. No.: 10/446,643

(22) Filed: May 28, 2003

Related U.S. Application Data
(63) Continuation-in-part of application No. 09/811,309, filed on Mar. 16, 2001, now Pat. No. 6,663,275.
Application No. 09/811,309 is a continuation-in-part of application No. 09/808,550, filed on Mar. 14, 2001, now abandoned.
Application No. 09/808,550 is a continuation-in-part of application No. 09/590,347, filed on Jun. 8, 2000, now Pat. No. 6,467,945.
Application No. 09/590,347 is a continuation-in-part of application No. 09/562,167, filed on May 2, 2000, now Pat. No. 6,409,376.

(51) Int. Cl. B01F 7/24

(52) U.S. Cl. 366/314; 366/603

(57) ABSTRACT

A mixer apparatus is disclosed for mixing livestock feed and the like. The apparatus includes a container for the reception therein of the feed. The container includes a housing and a wall extending away from the housing. The wall defines an opening which is disposed remote from the housing for the reception therethrough of the feed. The arrangement is such that the housing and the wall define therebetween an enclosure for the feed received through the opening. An auger is disposed within the enclosure, the auger having an axis of rotation which extends through the housing. A final driven wheel is disposed within the housing, the final driven wheel being rotatable about the axis of rotation. The final driven wheel is drivingly connected to the auger so that when the final driven wheel is rotated within the housing, the auger is rotated therewith within the enclosure. The final driven wheel and the auger together as a unit are removable and replaceable relative to the housing and enclosure respectively. The arrangement is such that when the final driven wheel and the auger are together as the unit removed, direct access to the final driven wheel is permitted.

Cross reference to related applications. This application is a continuation-in-part of co-pending application U.S. Ser. No. 09/811,309 filed March 15th 2001 which is a continuation-in-part of co-pending application U.S. Ser. No. 09/808,550 filed March 14th 2001 which is a continuation-in-part of co-pending application U.S. Ser. No. 09/590,347 filed June 8th 2000 which is a continuation-in-part of co-pending application U.S. Ser. No. 09/562,167 filed May 2nd 2000. All the subject matter of the aforementioned applications are incorporated herein by reference.

### BACKGROUND OF THE INVENTION

1. Field of the Invention

The present invention relates to a mixer apparatus for mixing livestock feed. More specifically, the present invention relates to a vertical auger mixer having at least one auger.

2. Information Disclosure Statement.

Cattle farming requires the mixing of various livestock feeds for subsequent distribution. Additionally, mixers can be used for mixing other materials such as composts and the like. Sometimes such mixing of feeds includes depositing at least one bale of hay into a mixer container together with other additives. The materials within the container are mixed by means of at least one auger which rotates within the container so that an intimate mixing of the contents of the container is obtained. Although many mixers employ a pair of horizontal interacting augers extending longitudinally along the container, several mixers have been proposed in which the auger or augers are disposed vertically.

In the prior art mixers of the vertical auger type, such mixers sometimes include a pair of augers in which the rotational axes of the augers are disposed spaced and parallel relative to each other. Furthermore, each of such augers is driven by a separate drive which supplies rotary motion to each of the augers from below.

Also, some mixers have a single auger. However, the aforementioned twin auger mixers suffer from the following drawbacks. First, the provision of two 90 degree drives and associated planetary reduction gearboxes is extremely expensive and involves the manufacture of many parts. Second, access to such gearboxes requires removal of the gearboxes from underneath the mixer and then disassembly of such gearboxes. Third, the augers include continuous flighting which provides less agitation of the feed. Fourth, at the end of a mixing operation, an operator will usually find it necessary to rev up the power take off in an attempt to throw materials centrifugally away from the augers so that the augers are cleaned. Fifth, when weighing materials to be mixed, inaccurate measurements are made when the mixer is on uneven ground. Such inaccuracies are caused mainly because when a load cell is disposed at the hitch of a drawbar, the reading reflects a vector rather than a vertical weight when the mixer is tilted. Most of the aforementioned drawbacks are also applicable to single auger mixers and the cost of providing a planetary gearbox and other parts is considerable.

Also, the apparatus according to the present invention includes a floor which is removable for permitting direct access to the final driven wheel, the floor being unfastened prior to removal of the auger such that removal of both the floor together with the auger as a unit is permitted.

The present invention provides a vertical auger mixer apparatus which overcomes all of the aforementioned problems associated with the prior art arrangements.

Therefore, it is a primary feature of the present invention to provide a mixer apparatus in which the floor is removable for permitting direct access to the final driven wheel, the floor being unfastened prior to removal of the auger such that removal of both the floor together with the auger as a unit is permitted.

Other features and advantages of the mixer apparatus according to the present invention will be readily apparent to those skilled in the art by a consideration of the detailed description contained herein of a preferred embodiment of the present invention.

### SUMMARY OF THE DISCLOSURE

The present invention relates to a mixer apparatus for mixing livestock feed. The apparatus includes a container for the reception therein of the feed. The container includes a housing and a wall extending away from the housing, the wall defining an opening disposed remote from the housing for the reception therethrough of the feed. The arrangement is such that the housing and the wall define therebetween an enclosure for the feed received through the opening. An auger is disposed within the enclosure, the auger having an axis of rotation which extends through the housing. The apparatus also includes a substantially horizontally disposed drive pinion and a final driven wheel which is driven by the drive pinion and disposed substantially horizontally within the housing. The pinion and final driven wheel intermesh and the final driven wheel is rotatable about the axis of rotation, the final driven wheel being drivingly connected to the auger so that when the final driven wheel is rotated within the housing, the auger is rotated therewith within the enclosure for mixing the feed. The housing also includes a floor which is disposed between the auger and the final driven wheel. The floor is removable for permitting direct access to the final driven wheel, the floor being unfastened prior to removal of the auger such that removal of both the floor together with the auger as a unit is permitted.

In a more specific embodiment of the present invention, the housing includes a base and a rim having a first and a second end, the rim being secured to the base. A floor is secured to the rim such that the floor is disposed between the base and the auger such that the base, the rim and the floor define therebetween an encasement for the final driven wheel.

Moreover, the floor defines an access hole for permitting removal and replacement therethrough of the final driven wheel when the floor is unfastened prior to removal of the auger.

Additionally, the floor includes a cover for covering the access hole. The cover defines an aperture through which the axis of rotation extends so that driving of the auger by the final driven wheel is permitted.

Furthermore, the cover includes a bearing which is disposed between the auger and the final driven wheel for bearingly supporting the auger for permitting rotation of the auger and the final driven wheel when the final driven wheel is being driven.

Also, the floor defines an array of bores which are disposed around the access hole, the cover having a peripheral edge which defines a plurality of holes. A plurality of fasteners is arranged with each fastener extending through a hole of the plurality of holes and an aligned bore of the array of bores for removably fastening the cover to the floor.

In another embodiment of the present invention, the mixer apparatus includes a container for the reception therein of the feed, the container including a housing and a wall which extends away from the housing, the wall defining an opening disposed remote from the housing for the reception therethrough of the feed. The arrangement is such that the housing and the wall define therebetween an enclosure for the feed received through the opening.

An auger is disposed within the enclosure, the auger having an axis of rotation extending through the housing. Also, a further auger is disposed within the enclosure, the further auger having a rotational axis which extends through the housing, the rotational axis being spaced and substantially parallel to the axis of rotation.

The apparatus also includes a substantially horizontally disposed drive pinion and a final driven wheel which is driven by the drive pinion and disposed substantially horizontally within the housing. The pinion and final driven wheel intermesh, the final driven wheel being rotatable about the axis of rotation. The final driven wheel is drivingly connected to the auger so that when the final driven wheel is rotated within the housing, the auger is rotated therewith within the enclosure for mixing the feed.

A further final driven wheel is driven by the drive pinion and is disposed substantially horizontally within the housing. The pinion and further final driven wheel intermesh and the further final driven wheel is rotatable about the rotational axis. The further final driven wheel is drivingly connected to the further auger so that when the further final driven wheel is rotated within the housing, the further auger is rotated therewith within the enclosure for mixing the feed.

The housing includes a floor which is disposed between the auger and the final driven wheel, the floor being removable for permitting direct access to the final driven wheel, the floor being unfastened prior to removal of the auger such that removal of both the floor together with the auger as a unit is permitted.

Additionally, the floor is disposed between the further auger and the further final driven wheel, the floor being removable for permitting direct access to the further final driven wheel, the floor being unfastened prior to removal of the further auger such that removal of both the floor together with the further auger as a further unit is permitted.

More specifically, the floor defines a further access hole for permitting removal and replacement therethrough of the further final driven wheel when the floor is unfastened prior to removal of the further auger.

Additionally, the floor includes a further cover for covering the further access hole. The further cover defines a further aperture through which the rotational axis extends so that driving of the further auger by the further final driven wheel is permitted.

Moreover, the further cover includes a further bearing which is disposed between the further auger and the further final driven wheel for bearingly supporting the further auger for permitting rotation of the further auger when the further final driven wheel is being driven.

Furthermore, the floor defines a further array of bores disposed around the further access hole. The further cover has a further peripheral edge which defines a further plurality of holes. A further plurality of fasteners is provided with each fastener of the further plurality of fasteners extending through a hole of the further plurality of holes and an aligned bore of the further array of bores for removably fastening the further cover to the floor.

Additionally, a removable plate is disposed within the cover and a further plate within the further cover such that when the plate and or the futher plate is removed, viewing and servicing of the drive pinion is permitted.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of a mixer apparatus according to the present invention having twin augers;

FIG. 1a is a perspective view of a mixer apparatus having a single auger;

FIG. 2 is a side elevational view of the mixer apparatus shown in FIG. 1a;

FIG. 3 is a top plan view of the mixer apparatus shown in FIG. 2.;

FIG. 4 is a top plan view of an alternative embodiment of the present invention;

FIG. 5 is a side elevational view of another embodiment of the present invention;

FIG. 6 is an enlarged side elevational view of the auger shown in FIG. 2;

FIG. 7 is an enlarged view of the drive gear pinion and driven wheel shown in FIG. 1a;

FIG. 8 is a top plan view similar to FIG. 7 of an alternative embodiment of the present invention;

FIG. 9 is a top plan view of a further embodiment of the present invention;

FIG. 10 is a diagrammatic representation viewed from the top of another embodiment of the present invention;

FIG. 11 is a top plan view of another embodiment of the present invention;

FIG. 12 is a sectional view taken on the line 12-12 of FIG. 11;

FIG. 13 is a view taken from beneath the mixer apparatus shown in FIG. 3;

FIG. 14 is an enlarged perspective view of the hitch bar as shown in FIG. 1; and

FIG. 15 is a side elevational view of the apparatus shown in FIG. 1.

Similar reference characters refer to similar parts throughout the various embodiments of the present invention.

### DETAILED DESCRIPTION OF THE DRAWINGS

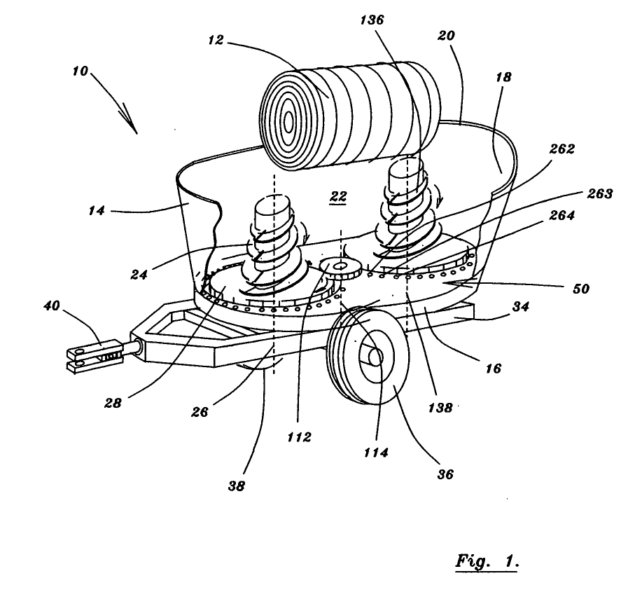

FIG. 1 is a perspective view of a mixer apparatus generally designated 10 for mixing livestock feed and the like 12. The apparatus 10 includes a container 14 for the reception therein of the feed 12. The container 14 includes a housing generally designated 16 and a wall 18 extending away from the housing 16. The wall 18 defines an opening 20 which is disposed remote from the housing 16 for the reception therethrough of the feed 12. The arrangement is such that the housing 16 and the wall 18 define therebetween an enclosure 22 for the feed 12 received through the opening 20. An auger 24 is disposed within the enclosure 22, the auger 24 having an axis of rotation 26 which extends through the housing 16. The mixer apparatus 10 further includes a further auger 136 which is disposed within the enclosure 22, the further auger 136 having a rotational axis 138 disposed approximately parallel and spaced from the axis of rotation 26 of the auger 24. The mixer 10 also has a drive wheel 112 which is common to the auger 24 and the further auger 136, the drive wheel 112 having a further axis of rotation 114 which is disposed spaced and approximately parallel relative to the axis of rotation 26 of the auger 24 and the rotational axis 138 of the further auger 136.

As shown in FIG. 1, the mixer apparatus 10 also includes a final driven wheel 28 disposed within the housing 16, the final driven wheel 28 being rotatable about the axis of rotation 26. The final driven wheel 28 is drivingly connected to the auger 24 so that when the final driven wheel 28 is rotated within the housing 16, the auger 24 is rotated therewith within the enclosure 22 for mixing the feed, the final driven wheel 28 being driven by the drive wheel 112.

As shown in FIG. 1, the container 14 further includes a frame 34 for supporting the housing 16 thereon. The container 14 also includes a plurality of wheels 36 and 38 which are rotatably secured to the frame 34 for permitting transportation of the mixer apparatus 10. Additionally, the container 14 includes a hitch bar 40 which is secured to the frame 34 for facilitating transportation of the mixer apparatus 10 by a tractor or the like (not shown).

FIG. 1a is a perspective view of another embodiment of the present invention in which the mixer has a single auger. It will be understood by those skilled in the art that the various features to be described relative to the single auger mixer are equally applicable to the twin auger mixer described with reference to FIG. 1. As shown in FIG. 1a, the housing 16′ includes a base 42 and a rim 44 having a first and a second end 46 and 48 respectively. The first end 46 of the rim 44 is secured to the base 42. A floor 50 is disposed between the auger 24′ and the final driven wheel 28′, the floor 50 being secured to the second end 48 of the rim 44 such that the base 42, the rim 44 and the floor 50 define therebetween an encasement 52 for the final driven wheel 28′. Furthermore, the floor 50 defines an access hole 54 for permitting removal and replacement therethrough of the final driven wheel 28′. The floor 50 includes a cover 56 which has been removed for clarity in FIG. 1. The cover 56 is for covering the access hole 54.

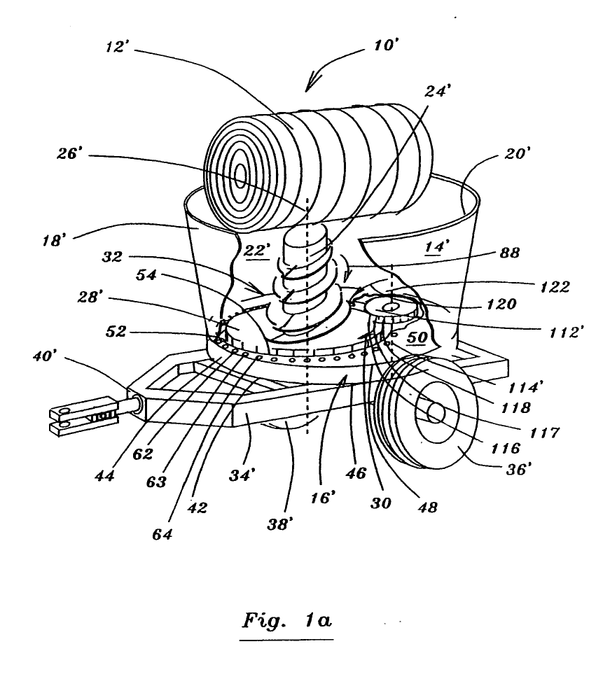

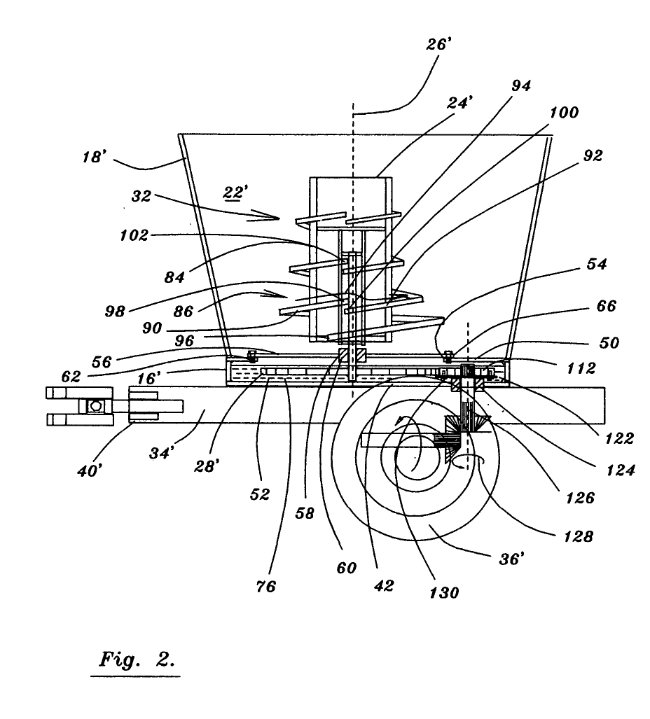

FIG. 2 is a side elevational view of the mixer apparatus shown in FIG. 1a. As shown in FIG. 2, the cover 56 defines an aperture 58 through which the axis of rotation 26′ extends so that driving of the auger 24′ by the final driven wheel 28′ is permitted. Moreover, the cover 56 includes a bearing 60 which extends through the aperture 58, the bearing 60 being disposed between the auger 24′ and the final driven wheel 28′ for bearingly supporting the auger 24′ and the final driven wheel 28′ for permitting rotation of the auger 24′ and the final driven wheel 28′ when the final driven wheel 28′ is being driven.

As also shown in FIGS. 1a and 2, the floor 50 defines an array of bores 62, 63 and 64 disposed around the access hole 54.

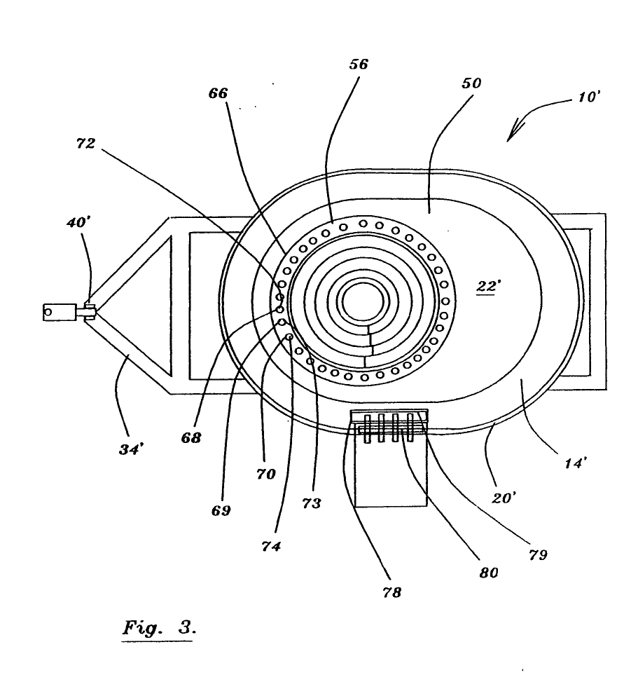

FIG. 3 is a top plan view of the apparatus 10′ shown in FIG. 2. As shown in FIG. 3, the cover 56 has a peripheral edge 66 which defines a plurality of holes 68, 69 and 70. A plurality of fasteners 72, 73 and 74 are arranged such that each fastener such as fastener 72 extends through a hole such as hole 68 of the plurality of holes 68-70 and an aligned bore such as bore 62 of the array of bores 62-64 shown in FIG. 1a for removably fastening the cover 56 to the floor 50. The encasement 52 is filled with lubricant 76 for lubricating the final driven wheel 28′ as shown in FIG. 2.

Also, as shown in FIGS. 1a-3, the wall 18′ extends angularly away from the housing 16′. Preferably, the wall 18′ defines a discharge outlet 78 shown in FIG. 3 for the discharge therethrough of the feed 12′. The discharge outlet 78 includes a door 79 and at least one rotary expeller 80 for moving the feed 12′ away from the enclosure 22′.

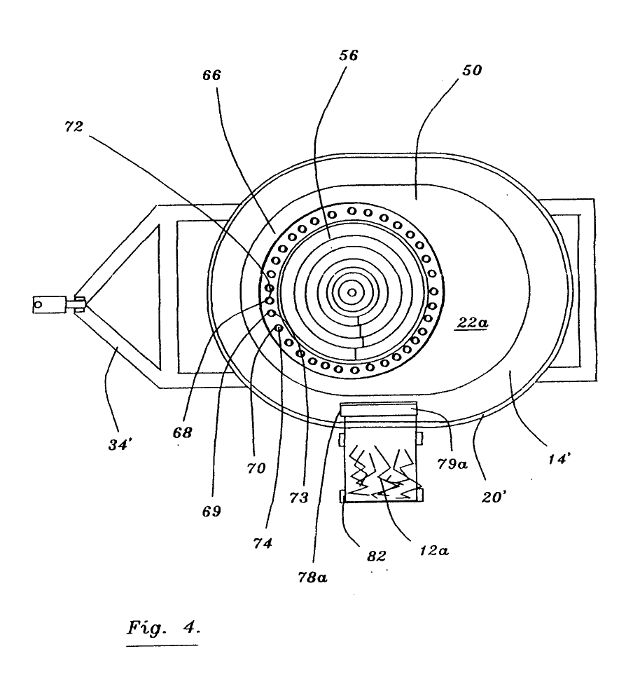

FIG. 4 is a top plan view of an alternative embodiment of the present invention. As shown in FIG. 4, a discharge outlet 78a includes a conveyor 82 for conveying the feed 12a away from the enclosure 22a and a door 79a which is movable relative to the discharge outlet 78a.

In another feature of the present invention as shown in FIG. 2, the auger 24′ includes a core 84 and flighting generally designated 86 is connected to the core 84 so that when the auger 24′ rotates as indicated by the arrow 88 as shown in FIG. 1a, feed 12′ disposed within the enclosure 22′ is mixed. The core 84 is of cylindrical configuration and the flighting 86 is disposed helically around the core 84. More specifically as shown in FIG. 2, the flighting 86 includes a first portion 90 and a second portion 92 which is staggered relative to the first portion 90 such that movement of the feed 12′ as indicated by the arrow 94 between the first and second portions 90 and 92 respectively is interrupted. The first portion 90 has a first and a second end 96 and 98 respectively and is of spiral configuration. The first end 96 is disposed adjacent to the housing 16′. The second portion 92 has a first and a second extremity 100 and 102 respectively, the first extremity 100 being disposed in an adjacent spaced relationship relative to the second end 98 of the first portion 90. The second portion 92 also is of spiral configuration. Those skilled in the art will appreciate that the core 84 could be of conical configuration or of square cross sectional configuration without departing from the spirit and concept of the present invention.

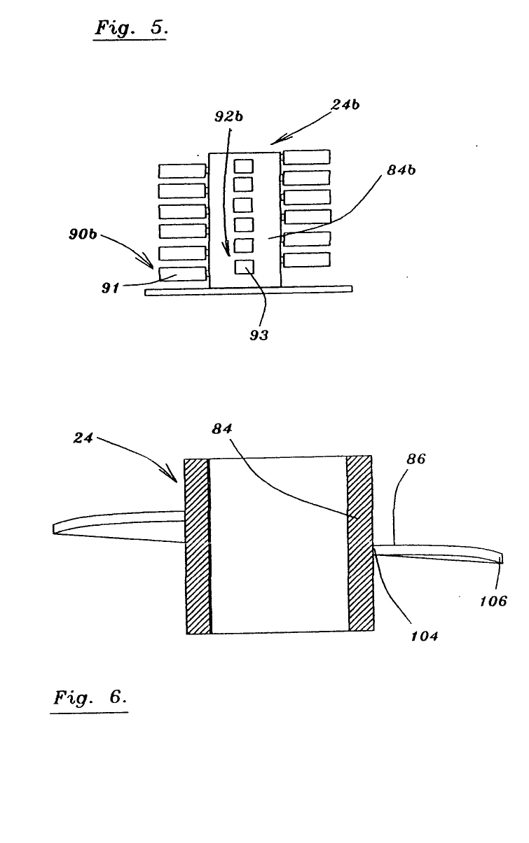

FIG. 5 is a side elevational view of another embodiment of the present invention. As shown in FIG. 5, an auger 24b includes a first portion 90b which is a paddle 91 and a second portion 92b is a further paddle 93. The further paddle 93 is disposed in staggered relationship with paddle 91 as shown in FIG. 5. Also, as shown in FIG. 5, both of the paddles 91 and 93 extend from a core 84b of the auger 24b.

FIG. 6 is an enlarged side elevational view of the auger 24′ shown in FIG. 2. As shown in FIG. 6, the flighting 86 has an inner edge 104 and an outer edge 106, the inner edge 104 being connected to the core 84. The outer edge 106 is canted towards the housing 16′ such that discharging and cleaning of feed 12′ from the auger 24′ during an unloading operation is facilitated.

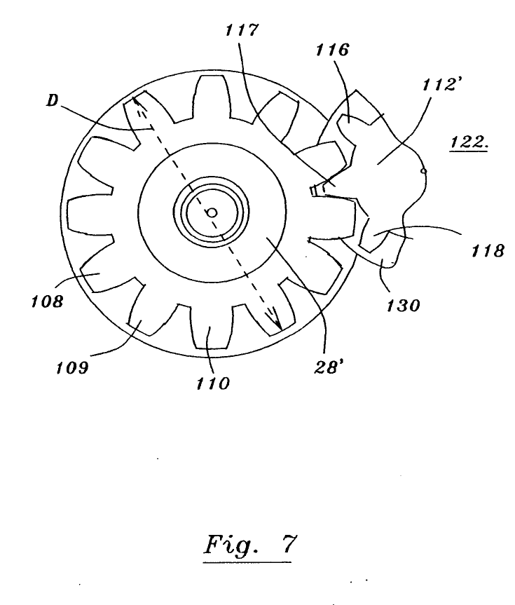

FIG. 7 is an enlarged top plan view of the final driven wheel 28′ shown in FIG. 1a. As shown in FIG. 7, the final driven wheel 28′ is a gear wheel. The gear wheel 28′ includes a plurality of straight teeth 108, 109 and 110. In a preferred embodiment of the present invention, the gear wheel 28′ has a diameter D of at least three foot.

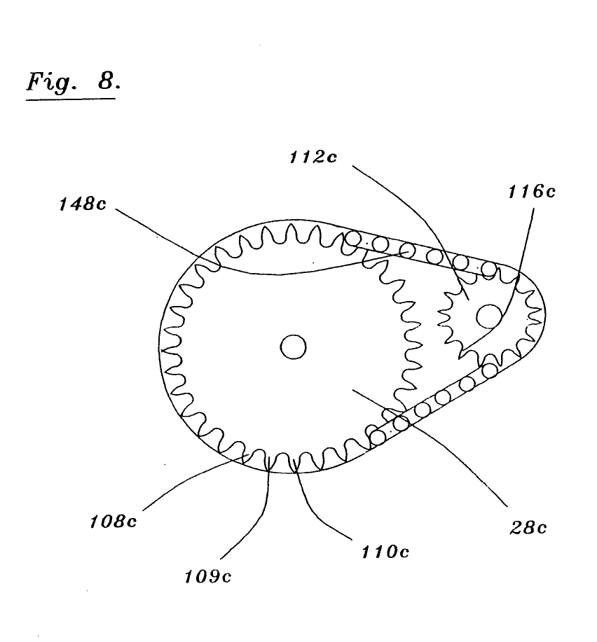

FIG. 8 is a top plan view similar to FIG. 7 of an alternative embodiment of the present invention. As shown in FIG. 8, the final driven wheel 28c is a driven sprocket wheel with driven sprocket teeth 108c, 109c and 110c. Also, as shown in FIG. 8, a drive wheel 112c is a sprocket having teeth 116c for driving the driven wheel 28c by a drive chain 148c.

As shown in FIG. 1a, the apparatus 10′ also includes a drive wheel 112′ having a further axis of rotation 114′ which is disposed spaced and approximately parallel to the axis of rotation 26′ of the auger 24′, the drive wheel 112′ driving the final driven wheel 28′. More particularly, the drive wheel 112′ is a drive gear pinion having a plurality of teeth 116, 117 and 118. The final driven wheel 28′ is a gear wheel having gear teeth 108-110 as shown in FIG. 7 which intermesh with the plurality of teeth 116-118 of the drive gear pinion 112′ so that when the drive gear pinion 112′ is rotated as indicated by the arrow 120, the final driven wheel 28′ and the auger 24′ ate rotated. The floor 50 is disposed between the auger 24′ and the final driven wheel 28′, the floor 50 being secured to the second end 48 of the rim 44 such that the base 42, the rim 44 and the floor 50 define therebetween the encasement 52 for the final driven wheel 28′. Also, as shown in FIG. 2, the floor 50 and the base 42 further define a cavity 122 for the reception therein of the drive gear pinion 112′. The mixer apparatus 10′ further includes a drive gear pinion bearing 124 which is secured to the base 42 for rotatably supporting the drive gear pinion 112′ within the cavity 122. A drive shaft 126 is secured to the drive gearpinion 112′, the drive shaft 126 extending through the housing 16′ so that when the drive shaft 126 is rotated as indicated by the arrow 128, the drive gear pinion 112′, the final driven wheel 28′ and the auger 24′ are rotated.

FIG. 7 is an enlarged view of the drive gear pinion 1112′ and driven wheel 28′. As shown in FIG. 7, the mixer apparatus 10′ further includes a guide 130 disposed in a vicinity of the plurality of teeth 116-118 of the drive gear pinion 112′ and the gear teeth 108-110 of the final driven wheel 28′. The arrangement is such that when the plurality of teeth 116-118 intermesh with the gear teeth 108-110 of the final driven wheel 28′, the intermeshing teeth 108-110 and 116-118 are guided by the guide 130 into an intermeshing relationship by the guide 130 as shown in FIG. 2. The guide 130 is secured to the drive gear pinion 112′ and is disposed between the drive gear pinion 112′ and the base 42 as shown in FIG. 2.

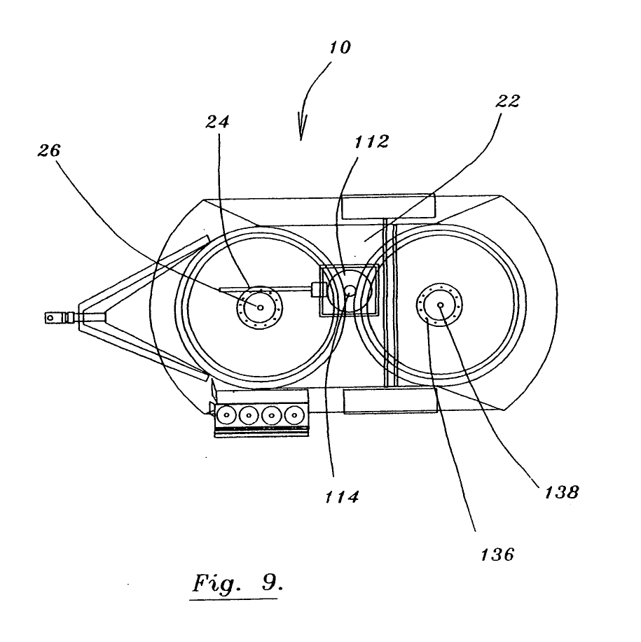

FIG. 9 is a top plan view of the mixer 10 shown in FIG. 1. As shown in FIG. 9, the further auger 136 is disposed within the enclosure 22, the further auger 136 having a rotational axis 138 disposed approximately parallel and spaced from the axis of rotation 26 of an auger 24.

As shown in FIG. 9, the drive wheel 112 is common to the auger 24 and the further auger 136. The drive wheel 112, part of which is shown in FIG. 9, includes the further axis of rotation 114 which is disposed spaced and approximately parallel relative to the axis of rotation 26 of the auger 24 and the rotational axis 138 of the further auger 136. The further axis of rotation 114 of the drive wheel 112 is disposed between the axis of rotation 26 of the auger 24 and the rotational axis 138 of the further auger 136.

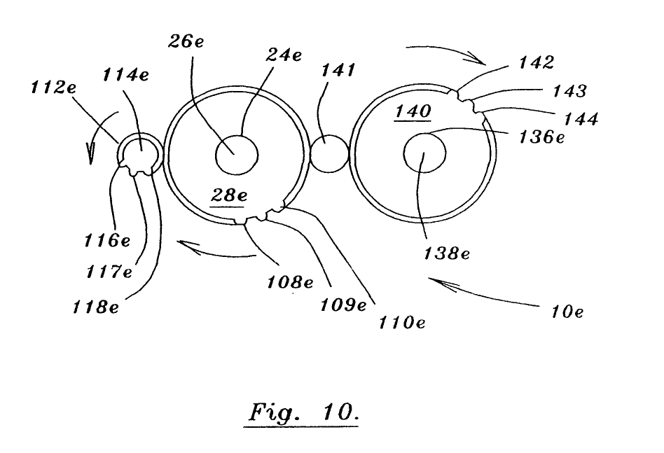

FIG. 10 is a diagrammatic representation viewed from the top of another embodiment of the present invention. As shown in FIG. 10, the axis of rotation 26e of the auger 24e and final driven wheel 28e is disposed between the further axis of rotation 114e of the drive wheel 112e and the rotational axis 138e of the further auger 136e. The drive wheel 112e is a drive gear pinion, the drive gear pinion having a plurality of teeth 116e-118e. The final driven wheel 28e is a gear wheel having gear teeth 108e-110e which intermesh with the plurality of teeth 116e-118e of the drive gear pinion 112e so that when the drive gear pinion 112e is rotated, the final driven wheel 28e and the auger 24e are rotated.

As shown in FIG. 10, the mixer apparatus 10e further includes a further final driven wheel 140, the further final driven wheel 140 being a further gear wheel having further gear teeth 142, 143 and 144 which are driven by the plurality of teeth 108e-110e of the driven wheel 28e. The arrangement is such that when the drive gear pinion 112e is rotated, the final driven wheel 28e and the auger 24e are rotated and the further final driven wheel 140 and further auger 136e are rotated. As shown in FIG. 10, a gear 141 is disposed between the wheels 28e and 140.

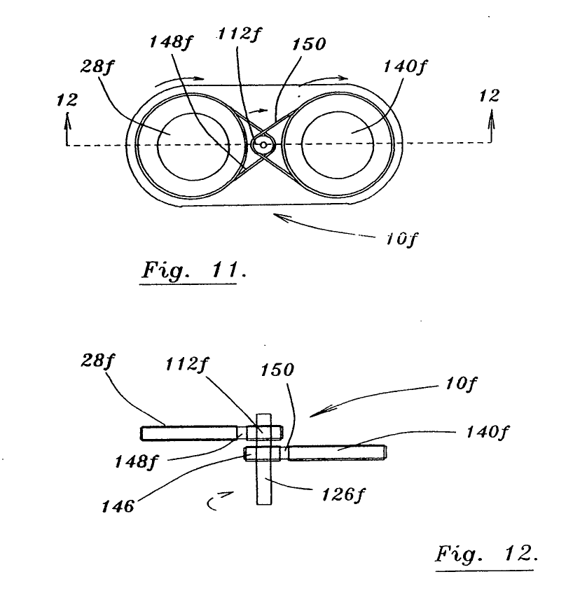

FIG. 11 is a top plan view of another embodiment of the present invention. As shown in FIG. 11, a drive wheel 112f is a first drive sprocket.

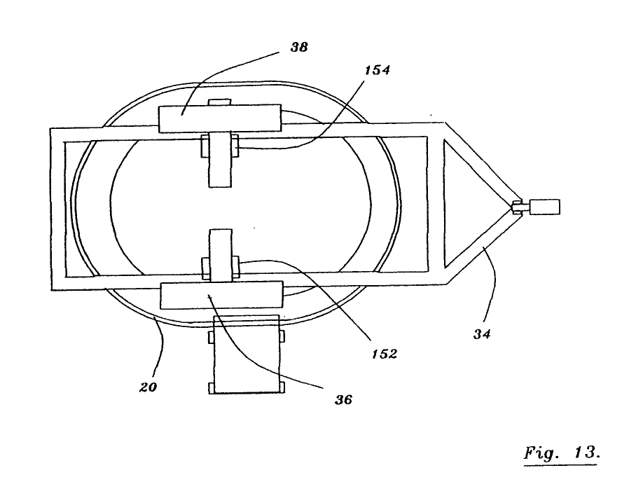

FIG. 12 is a sectional view taken on the line 12-12 of FIG. 11. As shown in FIG. 12, the mixer apparatus 10f further includes a second drive sprocket 146 which is secured to the first drive sprocket 112f and is disposed coaxially relative to the first drive sprocket 112f. A drive 148f extends around the first drive sprocket 112f and the final driven wheel 28f so that when the first drive sprocket 112f is rotated, the drive 148f rotates the final driven wheel 28f. Also, a further final driven wheel 140f is a further driven sprocket wheel. A further drive 150 extends around the second drive sprocket 146 and the further final driven wheel 140f so that when the second drive sprocket 146 is rotated, the further drive 150 rotates the further final driven wheel 140f. The drive 148f is a first roller chain drive and the further drive 150 is a second roller chain drive.

Those skilled in the art will appreciate that the arrangement shown in FIGS. 11 and 12 could include replacing the driven and drive sprockets with driven and drive pulleys with the drive roller chain being replaced with a belt drive. Similarly, the further driven and further drive sprockets and further roller chain drive could be replaced by a further driven pulley, further drive pulley and further drive belt respectively.

FIG. 13 is a view taken from beneath the mixer apparatus 10 shown in FIG. 3. As shown in FIG. 13, a plurality of wheels 36′ and 38′ shown in FIG. 1a includes the first wheel 36′and the second wheel 38′ disposed spaced and coaxial relative to the first wheel 36′. A first load cell 152 is disposed between the first wheel 36′ and the frame 34′ and a second load cell 154 is disposed between the second wheel 38′ and the frame 34′ as shown in FIG. 13.

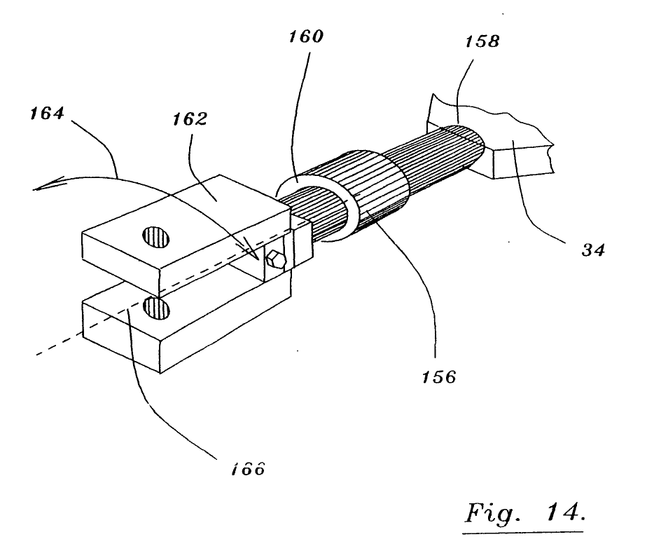

FIG. 14 is an enlarged perspective view of the hitch bar 40 as shown in FIG. 1. As shown in FIG. 14, the hitch bar 40 is connected to the frame 34 and is disposed remote from the wheels 36 and 38. A third load cell 156 has a first and a second end 158 and 160 respectively, the first end 158 of the third load cell 156 being secured to the frame 34. A clevis 162 is attached to the second end 160 of the third load cell 156, the clevis 162 being rotatable as indicated by the arrow 164, about a longitudinal axis 166 of the third load cell 156. The arrangement is such that during a weighing operation which is dependent on measurements from the first, second and third load cells 152, 154 and 156, the rotatable clevis 162 adjusts to a difference in an inclination of the mixer apparatus 10 and a tractor (not shown) so that side pressures and inaccuracies in measurements from the third load cell 156 is decreased.

Also, according to the present invention, as shown in FIG. 1a, the apparatus 10′ includes a container 14′ for the reception therein of the feed 12′. The container 14′ includes a housing 16′ and a wall 18′ extending away from the housing 16′, the wall 18′ defining an opening 20′ disposed remote from the housing 16′ for the reception therethrough of the feed 12′. The arrangement is such that the housing 16′ and the wall 18′ define therebetween an enclosure 22′ for the feed 12′ received through the opening 20′. An auger 24′ is disposed within the enclosure 22′, the auger 24′ having an axis of rotation 26′ which extends through the housing 16′. The apparatus also includes a substantially horizontally disposed drive pinion or drive wheel 112′ and a final driven wheel 28′ which is driven by the drive pinion 112′ and disposed substantially horizontally within the housing 16′. The pinion 112′ and final driven wheel 28′ intermesh and the final driven wheel 28′ is rotatable about the axis of rotation 26′, the final driven wheel 28′ being drivingly connected to the auger 24′ so that when the final driven wheel 28′ is rotated within the housing 16′, the auger 24′ is rotated therewith within the enclosure 22′ for mixing the feed 12′.

FIG. 2 is a side elevational view of the apparatus shown in FIG. 1a. As shown in FIG. 2, the housing 16′ also includes a floor 50 which is disposed between the auger 24′ and the final driven wheel 28′. The floor 50 is removable for permitting direct access to the final driven wheel 28′, the floor 50 being unfastened prior to removal of the auger 24′ such that removal of both the floor 50 together with the auger 24′ as a unit is permitted.

More specifically, the housing 16′ includes a base 42 and a rim 44 having a first and a second end 46 and 48 respectively, the rim 44 being secured to the base 42. The floor 50 is secured to the rim 44 such that the floor 50 is disposed between the base 42 and the auger 24′ such that the base 42, the rim 44 and the floor 50 define therebetween an encasement 52 for the final driven wheel 28′.

Moreover, the floor 50 defines an access hole 54 for permitting removal and replacement therethrough of the final driven wheel 28′ when the floor 50 is unfastened prior to removal of the auger 24′.

Additionally, the floor 50 includes a cover 56 for covering the access hole 54. The cover 56 defines an aperture 58 through which the axis of rotation 26′ extends so that driving of the auger 24′ by the final driven wheel 28′ is permitted.

Furthermore, the cover 56 includes a bearing 60 which is disposed between the auger 24′ and the final driven wheel 28′ for bearingly supporting the auger 24′ for permitting rotation of the auger 24′ and the final driven wheel 28′ when the final driven wheel 28′ is being driven.

Also, the floor 50 defines an array of bores 62, 63 and 64 which are disposed around the access hole 54.

FIG. 3 is top plan view of the apparatus shown in FIG. 2. As shown in FIG. 3, the cover 56 has a peripheral edge 66 which defines a plurality of holes 68, 69 and 70. A plurality of fasteners 72, 73 and 74 is arranged with each fastener such as fastener 72 extending through a hole such as hole 68 of the plurality of holes 68-70 and an aligned bore such as bore 62 of the array of bores 62-64 for removably fastening the cover 56 to the floor 50.

FIG. 1 is a perspective view of a twin auger apparatus according to the present invention. As shown in FIG. 1, the mixer apparatus 10 includes a container 14 for the reception therein of the feed 12, the container 14 including a housing 16 and a wall 18 which extends away from the housing 16, the wall 18 defining an opening 20 disposed remote from the housing 16 for the reception therethrough of the feed 12. The arrangement is such that the housing 16 and the wall 18 define therebetween an enclosure 22 for the feed 12 received through the opening 20.

An auger 24 is disposed within the enclosure 22, the auger 24 having an axis of rotation 26 extending through the housing 16. Also, a further auger 136 is disposed within the enclosure 22, the further auger 136 having a rotational axis 138 which extends through the housing 16, the rotational axis 138 being spaced and substantially parallel to the axis of rotation 26.

The apparatus 10 also includes a substantially horizontally disposed drive pinion or drive wheel 112 and a final driven wheel 28 which is driven by the drive pinion 112 and disposed substantially horizontally within the housing 16. The pinion 112 and final driven wheel 28 intermesh, the final driven wheel 28 being rotatable about the axis of rotation 26. The final driven wheel 28 is drivingly connected to the auger 24 so that when the final driven wheel 28 is rotated within the housing 16, the auger 24 is rotated therewith within the enclosure 22 for mixing the feed 12.

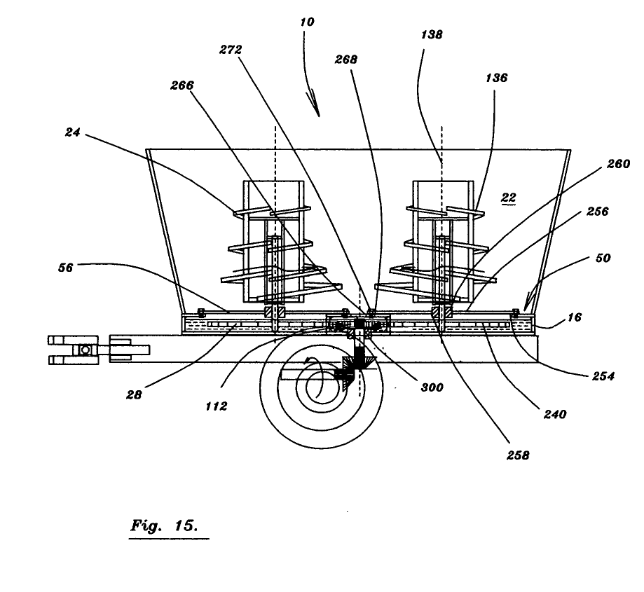

FIG. 15 is a side elevational view of the apparatus 10 shown in FIG. 1. As shown in FIG. 15, a further final driven wheel 240 is driven by the drive pinion 112 and is disposed substantially horizontally within the housing 16. The pinion 112 and further final driven wheel 240 intermesh and the further final driven wheel 240 is rotatable about the rotational axis 138. The further final driven wheel 240 is drivingly connected to the further auger 136 so that when the further final driven wheel 240 is rotated within the housing 16, the further auger 136 is rotated therewith within the enclosure 22 for mixing the feed 12.

The housing 16 includes the floor generally designated 50 which is disposed between the auger 24 and the final driven wheel 28, the floor 50 being removable for permitting direct access to the final driven wheel 28, the floor 50 being unfastened prior to removal of the auger 24 such that removal of both the floor 50 together with the auger 24 as a unit is permitted.

Additionally, the floor 50 is disposed between the further auger 136 and the further final driven wheel 240, the floor 50 being removable for permitting direct access to the further final driven wheel 240, the floor 50 being unfastened prior to removal of the further auger 136 such that removal of both the floor 50 together with the further auger 136 as a further unit is permitted.

More specifically, the floor 50 defines a further access hole 254 for permitting removal and replacement therethrough of the further final driven wheel 240 when the floor 50 is unfastened prior to removal of the further auger 136.

Additionally, the floor 50 includes a further cover 256 for covering the further access hole 254. The further cover 256 defines a further aperture 258 through which the rotational axis 138 extends so that driving of the further auger 136 by the further final driven wheel 240 is permitted.

Moreover, the further cover 256 includes a further bearing 260 which is disposed between the further auger 136 and the further final driven wheel 240 for bearingly supporting the further auger 136 for permitting rotation of the further auger 136 when the further final driven wheel 240 is being driven.

Furthermore, as shown in FIG. 1, the floor 50 defines a further array of bores 262, 263 an 264 disposed around the further access hole 254. As shown in FIG. 15, the further cover 256 has a further peripheral edge 266 which defines a further plurality of holes 268, 269 and 270 of which 268 only is shown for clarity. A further plurality of fasteners 272, 273 and 274 is provided of which 272 only is shown for clarity, with each fastener such as fastener 272 of the further plurality of fasteners 272-274 extending through a hole such as hole 268 of the further plurality of holes 268-270 and an aligned bore such as bore 262 of the further array of bores 262-264 for removably fastening the further cover 256 to the floor 50.

Additionally, a removable plate 300 is disposed within the cover 56 and a further plate 300′ within the further cover 256 such that when the plate 300 and or further plate 300′ is or are removed, viewing and servicing of the drive pinion 112 is permitted.

In operation of the mixer apparatus 10 according to the present invention, the cover 56 is unbolted from the floor 50 and the auger 24 and final driven wheel 28 are removed upwardly as a single unit so that immediate inspection and servicing of the final driven wheel 28 and drive wheel 112 is permitted. Also, reassembly of the unit 32 which includes the auger 24 and final driven wheel 28 is a simple operation in which the unit is lowered through the enclosure 22 followed by refastening the cover 56 to the floor 50.

The present invention provides a vertical auger mixer having a number of unique features which reduce the cost of production thereof and provide a mixer which permits easy access for inspecting and servicing the drive gears thereof.

1. A mixer apparatus for mixing livestock feed and the like, said apparatus comprising:
a container for the reception therein of the feed;
said container including:
a housing;
a wall extending away from said housing, said wall defining an opening disposed remote from said housing for the reception therethrough of the feed, the arrangement being such that said housing and said wall define therebetween an enclosure for the feed received through said opening;
an auger disposed within said enclosure, said auger having an axis of rotation extending through said housing;
a final driven wheel disposed within said housing, said final driven wheel being rotatable about said axis of rotation, said final driven wheel being drivingly connected to said auger so that when said final driven wheel is rotated within said housing, said auger is rotated therewith within said enclosure for mixing the feed; and
said housing including:
a floor disposed between said auger and said final driven wheel, said floor being removable for permitting direct access to said final driven wheel.

2. A mixer apparatus for mixing livestock feed, said apparatus comprising:
a container for the reception therein of the feed;
said container including:
a housing;
a wall extending away from said housing, said wall defining an opening disposed remote from said housing for the reception therethrough of the feed, the arrangement being such that said housing and said wall define therebetween an enclosure for the feed received through said opening;
an auger disposed within said enclosure, said auger having an axis of rotation extending through said housing;
a substantially horizontally disposed drive pinion;
a final driven wheel driven by said drive pinion and disposed substantially horizontally within said housing, said pinion and final driven wheel intermeshing, said final driven wheel being rotatable about said axis of rotation, said final driven wheel being drivingly connected to said auger so that when said final driven wheel is rotated within said housing, said auger is rotated therewith within said enclosure for mixing the feed; and
said housing including:
a floor disposed between said auger and said final driven wheel, said floor being removable for permitting direct access to said final driven wheel, said floor being unfastened prior to removal of said auger such that removal of both said floor together with said auger as a unit is permitted.

3. A mixer apparatus as set forth in claim 2 wherein said housing includes:
a base;
a rim having a first and a second end, said rim being secured to said base;
a floor secured to said rim such that said floor is disposed between said base and said auger such that said base, said rim and said floor define therebetween an encasement for said final driven wheel.

4. A mixer apparatus as set forth in claim 3 wherein said floor defines an access hole for permitting removal and replacement therethrough of said final driven wheel when said floor is unfastened prior to removal of said auger.

5. A mixer apparatus as set forth in claim 4 wherein said floor includes:
a cover for covering said access hole.

6. A mixer apparatus as set forth in claim 5 wherein said cover defines an aperture through which said axis of rotation extends so that driving of said auger by said final driven wheel is permitted.

7. A mixer apparatus as set forth in claim 6 wherein said cover includes:
a bearing disposed between said auger and said final driven wheel for bearingly supporting said auger for permitting rotation of said auger and said final driven wheel when said final driven wheel is being driven.

8. A mixer apparatus as set forth in claim 7 wherein said floor defines an array of bores disposed around said access hole;
said cover having a peripheral edge which defines a plurality of holes;
a plurality of fasteners, each fastener extending through a hole of said plurality of holes and an aligned bore of said array of bores for removably fastening said cover to said floor.

9. A mixer apparatus for mixing livestock feed, said apparatus comprising:
a container for the reception therein of the feed;
said container including:
a housing;
a wall extending away from said housing, said wall defining an opening disposed remote from said housing for the reception therethrough of the feed, the arrangement being such that said housing and said wall define therebetween an enclosure for the feed received through said opening;
an auger disposed within said enclosure, said auger having an axis of rotation extending through said housing;
a further auger disposed within said enclosure, said further auger having a rotational axis extending through said housing, said rotational axis being spaced and substantially parallel to said axis of rotation;
a substantially horizontally disposed drive pinion;
a final driven wheel driven by said drive pinion and disposed substantially horizontally within said housing, said pinion and final driven wheel intermeshing, said final driven wheel being rotatable about said axis of rotation, said final driven wheel being drivingly connected to said auger so that when said final driven wheel is rotated within said housing, said auger is rotated therewith within said enclosure for mixing the feed;
a further final driven wheel driven by said drive pinion and disposed substantially horizontally within said housing, said pinion and further final driven wheel intermeshing, said further final driven wheel being rotatable about said rotational axis, said further final driven wheel being drivingly connected to said further auger so that when said further final driven wheel is rotated within said housing, said further auger is rotated therewith within said enclosure for mixing the feed;
said housing including:
a floor disposed between said auger and said final driven wheel, said floor being removable for permitting direct access to said final driven wheel, said floor being unfastened prior to removal of said auger such that removal of both said floor together with said auger as a unit is permitted; and
said floor being disposed between said further auger and said further final driven wheel, said floor being removable for permitting direct access to said further final driven wheel, said floor being unfastened prior to removal of said further auger such that removal of both said floor together with said further auger as a further unit is permitted.

10. A mixer apparatus as set forth in claim 9 wherein said floor defines a further access hole for permitting removal and replacement therethrough of said further final driven wheel when said floor is unfastened prior to removal of said further auger.

11. A mixer apparatus as set forth in claim 10 wherein said floor includes:
a further cover for covering said further access hole.

12. A mixer apparatus as set forth in claim 11 wherein said further cover defines a further aperture through which said rotational axis extends so that driving of said further auger by said further final driven wheel is permitted.

13. A mixer apparatus as set forth in claim 12 wherein
said further cover includes:
a further bearing disposed between said further auger and said further final driven wheel for bearingly supporting said further auger for permitting rotation of said further auger when said further final driven wheel is being driven.

14. A mixer apparatus as set forth in claim 13 wherein
said floor defines a further array of bores disposed around said further access hole;
said further cover having a further peripheral edge which defines a further plurality of holes;
a further plurality of fasteners, each fastener of said further plurality of fasteners extending through a hole of said further plurality of holes and an aligned bore of said further array of bores for removably fastening said further cover to said floor.

15. A mixer apparatus as set forth in claim 9 further including:
a removable plate disposed between said cover and said further cover for covering said drive pinion such that when said plate is removed, viewing and servicing of said drive pinion is permitted.

16. A mixer apparatus as set forth in claim 9 further including:
a removable plate disposed within said cover such that when said plate is removed, viewing and servicing of said drive pinion is permitted.

17. A mixer apparatus as set forth in claim 9 further including:
a removable further plate disposed within said further cover such that when said further plate is removed, viewing and servicing of said drive pinion is permitted.
